(19) United States
(12) Patent Application Publication
(10) Pub. No.: US 2010/0132469 A1
(43) Pub. Date: Jun. 3, 2010

(54) Nano-PWAS: Structurally Integrated Thin-Film Active Sensors for Structural Health Monitoring

(75) Inventors: Victor Giurgiutiu, Columbia, SC (US); Bin Lin, Columbia, SC (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 12/628,363

(22) Filed: Dec. 1, 2009

Related U.S. Application Data
(60) Provisional application No. 61/200,532, filed on Dec. 1, 2008.

(51) Int. Cl. G01N 29/04; H01P 11/00; H01R 43/00

(52) U.S. Cl. 73/628; 29/600; 29/825; 977/953

(57) ABSTRACT

In an exemplary configuration, a system for structural health monitoring is provided. The system includes a battery-less nano-PWAS device, the device comprising an array of nano-PWAS transducers and a tag antenna.

### CROSS-REFERENCE TO RELATED APPLICATION

The present application is based on and claims priority to U.S. Provisional Application 61/200,532 having a filing date of Dec. 1, 2008, which is incorporated by reference herein.

### GOVERNMENT SUPPORT CLAUSE

The present invention was developed with funding from the National Science Foundation under award 0528873. Therefore, the government retains certain rights in this invention.

### BACKGROUND

The mounting costs of maintaining aging infrastructure and the associated safety issues are a growing concern. Many bridges and other structures are structurally deficient or functionally obsolete. In response to these growing concerns, structural health monitoring (SHM) sets forth to determine the health of a structure by monitoring over time a set of structural sensors and assessing the remaining useful life and the need for structural actions.

SHM involves determining the health of a structure from the readings of an array of permanently-attached sensors that are embedded into the structure and monitored over time. SHM can be performed in two ways, passive and active. Passive SHM includes monitoring a number of parameters such as loading stress, environment action, performance indicators, acoustic emission from cracks, and the like and inferring the state of structural health from a structural model. In contrast, active SHM performs proactive interrogation of the structure, detects damage, and determines the state of structural health from the evaluation of damage extend and intensity. Both approaches aim at performing a diagnosis of the structural safety and health, to be followed by a prognosis of the remaining life. Passive SHM uses passive sensors which only “listen” but do not interact with the structure. Therefore, such sensors do not provide direct measurement of the damage presence and intensity. Active SHM uses active sensors that interact with the structure and thus determine the presence or absence of damage. The methods used for active SHM resemble those of nondestructive evaluation (NDE), e.g., ultrasonics, eddy currents, and the like, only that they are used with embedded sensors. Hence, the active SHM could be seen as a method of embedded NDE. One widely used active SHM method employs piezoelectric wafer active sensors such as those described in U.S. Pat. No. 7,024,315 B2, which is incorporated by reference herein. Such sensors send and receive Lamb waves and determine the presence of cracks, delaminations, disbonds, and corrosion. Due to similarities to NDE ultrasonics, this approach is also known as embedded ultrasonics.

The type and efficiency of the SHM sensors play a crucial role in the SHM system success. Ideally, SHM sensors should be able to actively interrogate the structure and find out its state of health, its remaining life, and the effective margin of safety. Essential in this determination is to find out the presence and extend of structural damage. Currently, structural damage is determined during scheduled inspections with sophisticated NDE equipment and extensive labor costs. The challenge of SHM is to develop inexpensive active sensors that can be permanently placed on the monitored structure and assess, continuous or on-demand, the state of structural health.

In recent years, considerable progress has been achieved in developing NDE methods that actively interrogate the structure using guided Lamb and Rayleigh waves. However, conventional NDE transducers are relatively large and expensive; for SHM applications, smaller and inexpensive active sensors are needed. Recent SHM work has shown that piezoelectric wafers adhesively bonded to the structure may successfully emulate the NDE methodology (pitch-catch, pulse-echo, phased array) while being sufficiently small and inexpensive to allow permanent attachment to the monitored structure, see, e.g., FIG. 1.

However, the current methods for fabrication and installation of these sensors on engineering structures are rather limited in that pre-manufactured piezoelectric wafers are adhesively bonded to the structural surface. The bonding layer is susceptible to environmental ingression that may lead to loss of contact with the structural substrate. The bonding layer may also induce acoustic impedance mismatch with detrimental effects on damage detection. Not surprisingly, several issues impede development towards industrial acceptance and implementation of piezoelectric wafers including unacceptable durability and survivability, large power and voltage requirements due to poor efficiency of piezoceramic wafers, excessive variability and uncertainty in functional properties due to manual installation methods, which are labor intensive and subjected to extensive human error, inability to utilize advanced sensor architectures due to the use of bulk piezoceramics, and unsuitability for efficient wireless interrogation due to the inherent limitations of the basic approach.

While various implementations of structural health monitoring devices have been developed, and while various methodologies have been proposed to evaluate structural health, no design has emerged that generally encompasses all of the desired characteristics as hereafter presented in accordance with the subject technology. A built-in SHM system capable of detecting and quantifying damage would increase the operational safety and reliability, would conceivably reduce the number of unscheduled repairs, and would bring down maintenance cost.

### SUMMARY

In view of the recognized features encountered in the prior art and addressed by the present subject matter, improved apparatus and methodologies for implementing structural health monitoring (SHM) have been provided.

In an exemplary configuration, a system for structural health monitoring is provided. The system includes a battery-less nano-PWAS device, the device comprising an array of nano-PWAS transducers and a tag antenna.

In still another embodiment of the present disclosure, a method for fabricating a battery-less nano-PWAS device is described. The method includes forming a plurality of single-layer thin-film nano PWAS layers and stacking such single layers to form a plurality of multiple-layer nano-PWAS. Multiple-layer nano-PWAS are placed adjacent to one another to form an array of nano-PWAS transducers.

In yet another embodiment of the present disclosure, a method for structural health monitoring is provided. The method includes utilizing a system to perform structural health monitoring analysis, the system comprising a battery-less nano-PWAS device and a computer, wherein the device comprises an array of nano-PWAS transducers and a tag antenna.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 schematically illustrates (a) pitch-catch method; (b) pulse-echo method; (c) boded interface between PWAS and structure;

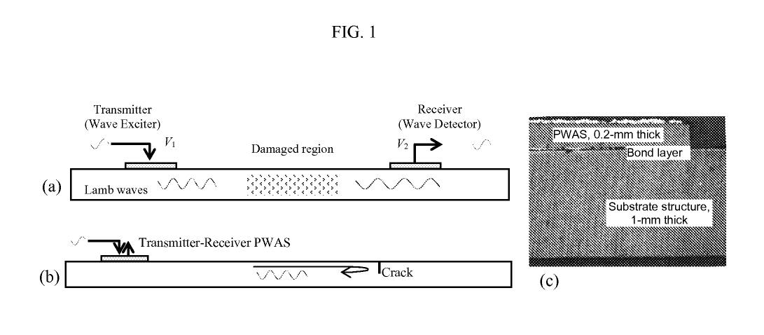

FIG. 2 illustrates sequential development of the multi-layer battery-less nano-PWAS phased array;

FIG. 3 illustrates (a) PZT plate with SAW type electrode; (b) impedance resonance of SAW type sensor;

FIG. 4 illustrates thin-film layered nano-PWAS that would require orders of magnitude lower voltage (0.015 V vs. 100 V) to achieve the same inplane strain (S₁=87.5 με);

FIG. 5 illustrates nano-PWAS phased array showing quasi-annular interdigitated electrodes to ensure axisymmetric wave propagation from each transducer;

FIG. 6 illustrates multi-physics FEM simulation of the electric field lines during the piezoelectric poling process; and

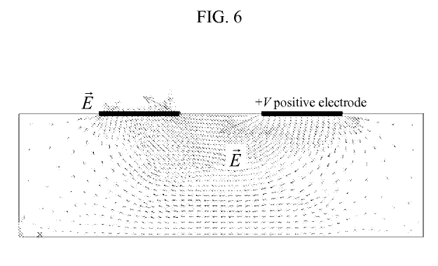

FIG. 7 illustrates a computer in accordance with the present subject matter.

Repeat use of reference characters throughout the present specification and appended drawings is intended to represent same or analogous features or elements of the invention.

### DETAILED DESCRIPTION

As discussed in the Summary of the Invention section, the present subject matter is particularly concerned with methods and apparatus for use in conjunction with structural health monitoring and evaluation.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

Reference will now be made in detail to the presently preferred embodiments of the subject structural health monitoring apparatus and methodology. In response to the needs discussed above, a new approach to SHM active sensors architecture is described herein. The new approach is based, in part, on objectives of a seamless atomic bond between the active sensor and the structure to ensure a durable and reliable connection between the active sensor and the structure, enhanced piezoelectric properties (coherent crystalline structure, well-oriented electric domains, new piezoelectric formulations) to improve the sensor's inherent response, in-situ fabrication of the active sensors directly on the structure, using direct-write technology, and ultra-low voltage layered architecture to permit direct wireless interrogation and autonomous operation using environmental energy harvesting.

It is estimated that implementation of this approach will permit orders of magnitude improvements in active SHM sensors performance and durability. The direct-write achievements in the microelectronics industry give credibility to the approach described herein.

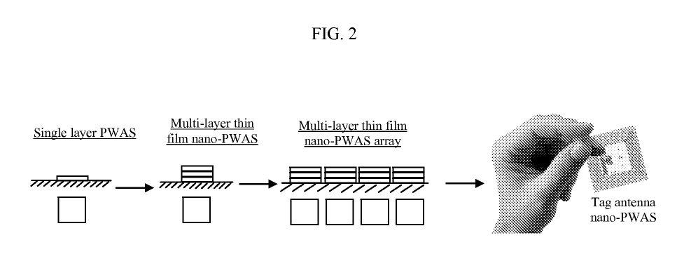

The novel approach described herein comprises using layered architecture in concern with guided wave SHM understanding and modeling to move from current single-layer PWAS to multilayer nano-PWAS, as shown in FIG. 2.

The thin film technologies described herein enable the development of highly-efficient active sensors. The present disclosure achieves wireless battery-less capability similar to the RFID tags that are presently available. In accordance with the present disclosure, a battery-less active sensor is provided that is powered only by an interrogating microwave beam aimed at it from a standoff distance. The new sensors (referred to herein as “nano-PWAS” due to the thin-films nano size) is developed in incremental steps as follows:
(a) Single-layer thin-film nano-PWAS;
(b) Multi-layer thin-film nano-PWAS;
(c) Micro phased array of nano-PWAS transducers; and
(d) Wireless battery-less operation via tag antenna.

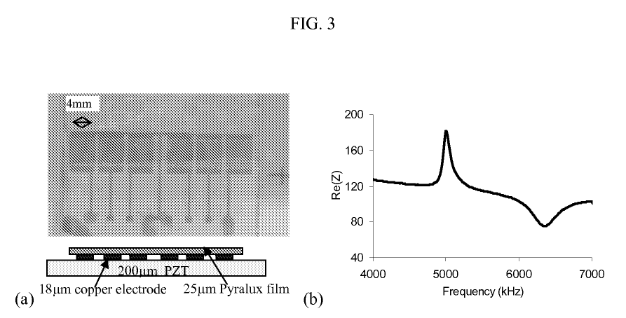

The single-layer thin-film nano-PWAS comprises thin piezoelectric film directly deposited on a structural substrate with an electrode pattern deposited on top. The use of an interdigitated (IDT) electrode pattern can permit tuning in selected MHz frequencies, as appropriate to the size and type of structural damage that needs to be detected. Previous work has proven that the deposition of ferroelectric thin film on structural materials is feasible. The feasibility of constructing IDT electrodes on piezoelectric substrates and using them to energize surface acoustic waves (SAW) has also been tested. The IDT electrode approach was selected because it permits a better coupling with SAW and Lamb waves used in the damage detection processes. FIG. 3A shows an IDT electrode pattern fabricated on Dupont Pyralux copper-clad flexible laminate by photolithography technique. Each SAW type sensor in array comprises five pairs of electrodes. The electrode finger is about 200 μm width with about 200 μm space. The aperture of the device was 4 mm. The resonance of this SAW-type device was measured with an HP4194 impedance analyzer; the resonance frequency of ˜5 MHz (FIG. 3b) is close to the design value.

The realization of a multi-layer thin-film construction is important for the success of the nano-PWAS sensor described herein. This aspect can be easily illustrated through the following 1-D analysis of a piezo wafer with top and bottom electrodes: recall the linear piezoelectric equations for 31 coupling between the E₃ electric field and S₁ strain and T₁ stress, i.e.,

S₁=s₁₁T₁+d₃₁E₃ (1)

Equation (1) expresses the strain in terms of two variables, the mechanical stress T₁ and the electric field E₃. The part of the strain due to the piezoelectric effect, S₁^{piezo}, is obtained by making T₁=0, i.e.,

S₁^{piezo}=d₃₁E₃ (2)

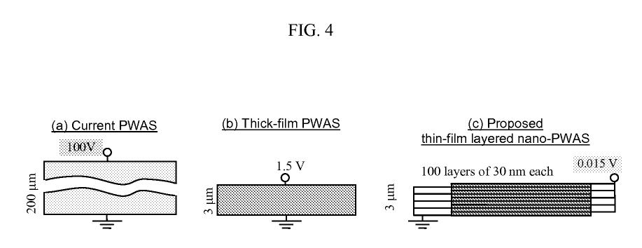

For practical PZT properties, Equation (2) demonstrates that an inplane strain S₁^{piezo}=87.5 με could be obtained with an electric field E₃=0.5 kV/mm. For a typical PZT wafer of thickness h=200 μm, this means a quite sizable applied voltage V=hE₃=100 V. The associate power can be approximated as

$$P = \frac{1}{2 } ω {CV}^{2} \qquad ( 3 )$$

where ω is the operating frequency and C=Nε₃₃A/h is the capacitance, with N the number of layer, A=bl the electrode area, ε₃₃ the electric permittivity of the piezo material. At approximately 100 kHz operation, Equation (3) yields P_{200μm}^{1-layer}=˜12 W. This situation, 100 V and ˜12 W, reflects the state-of-the-art piezoceramic wafer technology (FIG. 4A).

Replacing the 200-μm piezoceramic wafer with a 3-μm ferroelectric thick-film will decrease the voltage needed to achieve S₁^{piezo}=87.5 με induced strain from 100 V to only 1.5 V (FIG. 4B). The required power decreases from ˜12 W to a mere ˜0.180 W. However, the voltage value of 1.5 V is still too large for microwave-powered battery-less operation.

The voltage requirements can be further decreased to bring them within microwave energized capabilities by adopting a multi-layer construction (FIG. 4C); for N=100 layers of 30 nm each, the above calculations yield a voltage of mere 0.015 V. This indicates that the thin-film nano-PWAS described herein will decrease the required voltage by orders of magnitude less than current piezoceramic wafers (0.015 V vs. 100 V) and enable a microwave-powered battery-less wireless operation.

The next step in complexity in accordance with the present disclosure is to use the multi-layer nano-PWAS to create micro phased arrays. Extensive experience with the use of PWAS phased arrays for efficient large-area damage detection from a single location exists. However, an inherent shortcoming and limitation of the phased array approach is the existence of a blind area in the array's near field. The blind area radius R is commensurable with the array aperture D, where D≈Mλ/2, where M is the number of elements in the array and λ is the wavelength of the particular Lamb wave mode excited in the structure (λ=c/f). Previous studies on Lamb wave tuning with PWAS transducers have indicated that maximum excitation of a certain Lamb wave mode happens when the PWAS size a is in a certain relationship with the half wavelength λ/2. In accordance with the present disclosure, in order to reduce the blind area, PWAS transducers of smaller size a should be constructed. For example, a ten fold reduction in PWAS size a can ensure a ten fold reduction in the blind area D as well as a ten fold increase in the damage detection resolution 1/λ. For these reasons, the development of nano-PWAS with small surface footprint (about 10-100 μm) can ensure a small phased array aperture and hence small blind areas, as well as very good damage detection resolution.

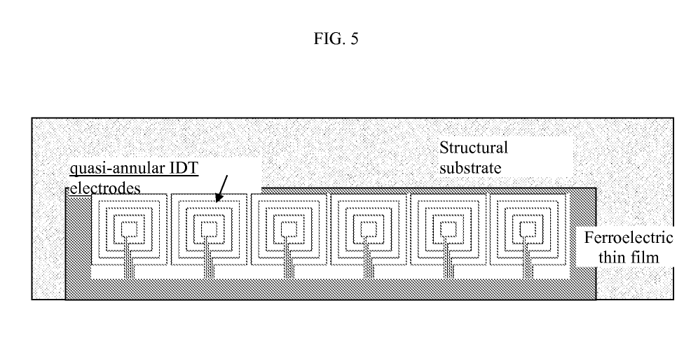

A schematic of the proposed nano-PWAS phased array concept using annular IDT electrodes is presented in FIG. 5. The annular IDT electrodes design was selected to ensure axisymmetric wave propagation from each transducer. The electrodes planform was selected to be quasi-square in order to ensure an optimum coverage of the ferroelectric thin-film area; the corner effects in the wave field quickly even out, as revealed by numerical simulation. The IDT electrodes, which exploit the half-wavelength tuning with the selected Lamb-wave mode, can ensure that a quasi-radial electric field is created and that the field alternates in sign between one electrode pair and the next. Through the half-wavelength relationship, this excitation pattern will ensure that the elastic ultrasonic Lamb waves emanate outward from the nano-PWAS center, and each nano-PWAS can be approximated with a point source in the idealized phased-array scheme. The IDT electrodes are reproduced identically at each after each ferroelectric thin-film layer.

A major challenge in the SHM usability of the proposed nano-PWAS device is to give it a non-battery wireless operational capability. In accordance with the present disclosure, each nano-PWAS with a miniature tag antenna can be remotely interrogated with microwave wireless power. The microwave beam pulse will energize the nano-PWAS into sending an interrogating Lamb wave/SAW pulse into the surrounding structure. The reflected/diffracted acoustic waves received back by the nano-PWAS will be transduced back into microwave field and emitted through the tag antenna. From an electromagnetic standpoint, this operation is similar to the well proven RFID technology. Transduction between electromagnetic and acoustic domains can be used to detect the incipient damage presence. Separation of damage diffractions from those due to structural features and boundaries, capability to detect weak acoustic wave signals and transduce them into electromagnetic waves of sufficient power to ensure adequate reception and interpretation, and development of new phased-array principles amenable to remote wireless interrogation, are all addressed herein using previous work on damage detection with embedded PWAS arrays.

For instance, a novel statistics-based differential imaging approach in accordance with the present disclosure can address separation of damage diffractions from those due to structural features and boundaries. The capability to detect weak acoustic wave signals and transduce them into electromagnetic waves of sufficient power to ensure adequate reception and interpretation can be addressed by building on previous work on efficient power and energy transfer through optimal interaction structural acoustic waves and PWAS transducers. Development of new phased-array principles amenable to remote wireless interrogation will be addressed by developing new principles of indexed-addressing of phased-array elements through wave modulation/encoding.

Analytical models for the electro-mechanical-acoustical analysis of the interaction between piezoelectric wafer active sensors (PWAS) and the guided-Lamb waves in the substrate structure have been developed previously. Analytical models of the bonding layer shear transfer and space-domain wavenumber Fourier analysis of the guided Lamb waves reveal the possibility of preferential tuning of various Lamb-wave modes, which have been experimentally confirmed. Tuned Lamb waves generated with PWAS arrays have been used to create guided-wave scanning beams to interrogate large structural areas. However, these arrays were much less effective when applied to small and compact structural parts of complicated geometry. It was found that the tuned wavelength was insufficiently small to permit small area/incipient damage detection and that the blind area was relatively large. The thin-film approach of the present disclosure will provide a much smaller array for effective damage detection.

Predictive modeling and experimental tests are used to achieve the nano-PWAS developmental steps outlined herein, from single-layer thin-film nano-PWAS up to the micro-phased array and the non-battery wireless operation. Modeling and experimental analysis of the piezoelectric interactions in the ferroelectric thin-film sensor applied to the structural substrate can be conducted in accordance with the present disclosure to show the use a multi-physics FEM code to analyze the poling process in a simple configuration. To achieve full understanding, this approach is used to analyze the multitude of piezoelectric interactions and optimize the multi-layer configuration, ferroelectric thin-film/electrode thin-film ratio, antenna configuration, and the like. In addition, reduced-order analytical methods to perform wider parameter search and optimization are contemplated in accordance with the present disclosure.

Further, modeling and experimental analysis of the tuning between ferroelectric thin-film active sensor array and multi-mode dispersive Lamb waves in the structure can build on PWAS tuning expertise to address the complicated problems appearing in multi-layer nano-PWAS working a MHz frequencies in micro phased arrays

Lastly, damage detection simulation and experimental validation with multi-layer nano-PWAS and performance and durability testing of multi-layer nano-PWAS are also contemplated in accordance with the present disclosure.

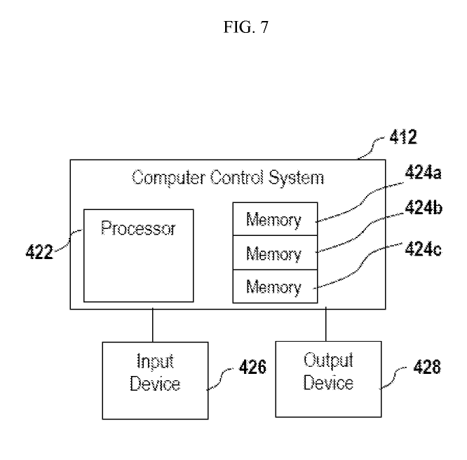

The sensors described herein can be utilized in conjunction with one or more computers. Computer 412 may generally include such components as at least one memory/media element or database for storing data and software instructions as well as at least one processor. In the particular example of FIG. 7, a processor(s) 422 and associated memory/media elements 424a, 424b and 424c are configured to perform a variety of computer-implemented functions (i.e., software-based data services). At least one memory/media element (e.g., element 424b in FIG. 7) is dedicated to storing software and/or firmware in the form of computer-readable and executable instructions that will be implemented by the one or more processor(s) 422. Other memory/media elements (e.g., memory/media elements 424a, 424c) are used to store data which will also be accessible by the processor(s) 422 and which will be acted on per the software instructions stored in memory/media element 424b. The various memory/media elements of FIG. 7 may be provided as a single or multiple portions of one or more varieties of computer-readable media, such as but not limited to any combination of volatile memory (e.g., random access memory (RAM, such as DRAM, SRAM, etc.) and nonvolatile memory (e.g., ROM, flash, hard drives, magnetic tapes, CD-ROM, DVD-ROM, etc.) or any other memory devices including diskettes, drives, other magnetic-based storage media, optical storage media and others. Although FIG. 7 shows three separate memory/media elements 424a, 424b and 424c, the content dedicated to such devices may actually be stored in one memory/media element or in multiple elements, any such possible variations and other variations of data storage will be appreciated by one of ordinary skill in the art.

In one particular embodiment of the present subject matter, a first portion of memory/media 424a is configured to store input data for the subject structural health monitoring system. Input data stored in memory/media element 424a may include raw measurement data nano-PWAS array. Data in memory 424a may also include input parameters provided from a user. Although such user-established limits and other input data may be pre-programmed into memory/media element 424a, they may also be entered as input data from a user accessing an input device 426, which may correspond to one or more peripheral devices configured to operate as a user interface with computer 412. Exemplary input devices may include but are not limited to a keyboard, touch-screen monitor, microphone, mouse and the like.

Second memory element 424b includes computer-executable software instructions that can be read and executed by processor(s) 422 to act on the data stored in memory/media element 424a to create new output data (e.g., damage data) for storage in a third memory/media element 424c. Such output data may be provided to a peripheral output device 428, such as monitor, printer or other device for visually depicting the output data, or as control signals to still further components. Computing/processing device(s) 422 may be adapted to operate as a special-purpose machine by executing the software instructions rendered in a computer-readable form stored in memory/media element 424b. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific circuits.

Structurally-integrated thin-film active sensors for structural health monitoring dubbed nano-PWAS are disclosed herein. As discussed previously, SHM is an emerging field in which smart materials interrogate structural components to predict failure, expedite needed repairs, and thus increase the useful life of those components. PWAS have been previously adhesively-bonded to structures and demonstrate the ability to detect and locate cracking, corrosion, and disbonding through use of pitch-catch, pulse-echo, electro/mechanical impedance, and phased array technology. The present disclosure describes structurally-integrated PWAS that can be fabricated directly to the structural substrate using thin-film nano technologies (e.g., pulsed-laser deposition, sputtering, chemical vapor deposition, etc.) Because these novel PWAS are made up of nano layers they are dubbed nano-PWAS. The present disclosure describes the nano-PWAS architectures that can be considered in the nano-PWAS constructions and how they are related to the active SHM interrogation methods. Such nano-PWAS architectures can be achieved through various thin-film deposition technologies that are currently available.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for structural health monitoring comprising:
a battery-less nano-PWAS device, the device comprising an array of nano-PWAS transducers and a tag antenna.

2. A system as in claim 1, wherein the device is configured to be powered by an interrogating microwave beam.

3. A system as in claim 1, wherein the array comprises multi-layer thin-film nano PWAS.

4. A system as in claim 3, wherein each layer of the multi-layer thin-film nano PWAS comprises an interdigitated electrode pattern.

5. A system as in claim 1, wherein each layer has a thickness of less than about 50 nm.

6. A system as in claim 1, wherein the device is wireless.

7. A system as in claim 1, wherein the system is configured to detect damage in a monitored structure.

8. A system as in claim 1, wherein the device is fabricated to a structural substrate.

9. A system as in claim 1, wherein the device has a required voltage of less than about 1 V.

10. A system as in claim 1, wherein the device is configured to provide a structural health monitoring analysis.

11. A system as in claim 10, wherein the structural health monitoring analysis comprises a damage index.

12. A method for fabricating a battery-less nano-PWAS device comprising
forming a plurality of single-layer thin-film nano PWAS layers and stacking such single layers to form a plurality of multiple-layer nano-PWAS;
placing multiple-layer nano-PWAS adjacent to one another to form an array of nano-PWAS transducers.

13. A method as in claim 12, further comprising providing one or more tag antenna.

14. A method as in claim 12, wherein each single layer comprises an interdigitated electrode pattern.

15. A method as in claim 12, wherein each single layer has a thickness of less than about 50 nm.

16. A method as in claim 12, further comprising fabricating the device to a structural substrate.

17. A method as in claim 12, wherein the device has a required voltage of less than about 1 V.

18. A method for structural health monitoring comprising:
utilizing a system to perform structural health monitoring analysis, the system comprising a battery-less nano-PWAS device and a computer, wherein the device comprises an array of nano-PWAS transducers and a tag antenna.

19. A method as in claim 18, further comprising powering the device by an interrogating microwave beam.

20. A method as in claim 18, wherein the device has a required voltage of less than about 1 V.
